(19) United States
(12) Patent Application Publication
(10) Pub. No.: US 2007/0122611 A1
(43) Pub. Date: May 31, 2007

(54) Sheet paper for irregular reflection and method of fabricating the same

(76) Inventor: Kyung Tae Park, Busan (KR)

Correspondence Address: IPLA P.A., 3580 WILSHIRE BLVD., 17TH FLOOR, LOS ANGELES, CA, 90010, US

(21) Appl. No.: 10/595,796

(22) PCT Filed: Nov. 3, 2004
(86) PCT No.: PCT/KR04/02823

§ 371 Date: May 11, 2006

(30) Foreign Application Priority Data
Nov. 12, 2003 (KR) 10-2003-0079687

(51) Int. Cl. C08J 7/04

(52) U.S. Cl. 428/341

(57) ABSTRACT

Disclosed herein is a sheet paper for irregular reflection. The sheet paper comprises, from the top thereof, a coating layer on which a hemispherical embossing is repeatedly formed at the one side of the sheet paper, a colored transparent paint film layer formed at the bottom surface of the coating layer having the embossing formed thereon, a glass bead layer formed on the bottom surface of the colored transparent paint film and having glass beads dispersed therein, a colorless transparent paint film layer formed on the bottom surface of the glass bead layer, and a silver paint film layer formed on the bottom surface of the colorless transparent paint film layer, wherein the glass beads are uniformly distributed and fixed in the colored transparent paint film layer and the colorless transparent paint film layer in such a manner that the surface of each bead is embedded in both layers by a half of the bead diameter respectively.

### TECHNICAL FIELD

The present invention relates to a sheet paper for irregular reflection and a method of fabricating the same. More particularly, the invention relates to a sheet paper for irregular reflection, in which a coating layer having an embossing formed thereon, a colored transparent paint film layer, a glass bead layer, a colorless transparent paint film layer, and a silver paint film (Al paste) layer are formed in the described order from the top thereof, and the glass bead layer is embedded and fixed in the colored transparent paint film layer and the colorless transparent paint film layer respectively by one half of the diameter of glass bead, thereby preventing surface damage of the glass bead through the coating layer formed with the embossing, and simultaneously maximizing the irregular reflection efficiency due to a secondary refraction of light through the coating layer formed with the embossing, and a method of fabricating such a sheet paper.

### BACKGROUND ART

In general, a reflective sheet paper utilizes various reflection phenomena such as recursive reflection, irregular reflection, or the like. Among them, a nighttime-discernible product uses recursive reflection.

According to the recursive reflection, light rays emitted from a light source is reflected on the surface of an object and returned to the light source. The recursive reflection material reflects any light towards the light source thereof, regardless of incident angle of the light. That is, if light from a car headlight or a flashlight is reflected on a recursive reflective material, the reflected light is returned in the incident direction, so that a person in the side of the light source can be readily discernible.

### DISCLOSURE OF INVENTION

### Technical Problem

In a sheet paper using the recursive reflection, a colorless transparent paint is coated on the top of a silver paint film to form a film layer, and a glass bead is fixed on the top of the colorless transparent paint film. Such sheet papers are widely used as a nighttime discernible safety vest and a load sign, and for the purpose of decoration. However, various colors of the sheet paper are visually hidden due to the light. Also, its color and shape can be discernible only from the light-incident direction, and cannot be seen from other directions, so that it embraces a potential danger for a safety accident due to vanish of the above discerning function.

In addition, since the outer surface of the glass bead fixed on the top of the silver paint film is exposed, the bead surface may be damaged and degraded in the reflection function due to contact with rain water or foreign matters and the reflection efficiency is decreased by the above contamination. Furthermore, due to the degradation in the reflection efficiency, the sheet paper must be frequently replaced, and when it cannot be replaced, the whole product must be exchanged, thereby shortening the lifespan thereof.

Recently, a plane protective coating layer has been formed on the top of the glass bead, so that it may avoid damage of the glass bead, but degrades reflection efficiency and produces recursive reflection only. That is, it does not provide the effect of discerning an object through light propagation and scattering caused by irregular reflection, without any light source. Therefore, it does not provide a complete solution to the problems occurring in the conventional recursive reflective sheet paper.

### Technical Solution

Therefore, the present invention is intended to propose a sheet paper, in which an embossing is formed on the top of a coating layer so that the color and shape thereof can be discernible from any directions through irregular reflection of the radiated light, and glass beads are dispersed such that one half of the diameter thereof is embedded and fixed equally in a colored transparent paint film layer and a colorless transparent paint film layer respectively, thereby maximizing the coating ratio of the glass bead and the colorless transparent paint.

The present invention has been made in order to solve the above problems occurring in the prior art, and it is an object of the invention to provide a sheet paper for irregular reflection, in which an embossing having a shape of hemisphere is formed on the top of a coating layer for protecting glass beads, and the glass beads are dispersed such that one half of the diameter thereof is embedded and fixed equally in a colored transparent paint film layer and a colorless transparent paint film layer respectively, so that light primarily reflected on a silver paint film layer formed below the colorless transparent paint film layer is secondarily refracted through the coating layer formed of embossing to thereby maximize irregular reflection effect, the embossing formed on the coating layer can generate irregular reflection to provide a good nighttime discernibility without a light source, and the glass bead and the colorless transparent paint are optimally dispersed to maximize the reflection efficiency, and also to provide a method of fabricating the above sheet paper.

### Advantageous Effects

According to the sheet paper of the invention, an embossing is formed on the top of a coating layer, a paint film is formed with a transparent paint, and then a glass bead is uniformly dispersed in the paint film layer to thereby provide an optimum arrangement of glass beads, and the light primarily reflected on a silver paint layer through the glass bead is secondarily refracted through the coating layer formed of embossing to thereby maximize irregular reflection efficiency.

### DESCRIPTION OF DRAWINGS

Further objects and advantages of the invention can be more fully understood from the following detailed description taken in conjunction with the accompanying drawings, in which:

FIG. 1 shows a cross-section of a sheet paper having a glass bead particle layer, in which a shaft-type bead and a round-type bead are mixed at a ratio of 50:50 according to the invention;

FIG. 2 illustrates a cross-section of a sheet paper having a uniform glass bead layer according to the invention;

FIG. 3 is a graph showing the types of glass bead dispersion in a sheet paper of the invention;

FIG. 4 is a cross-section showing a formation process of the embossing in the sheet paper of the invention;

FIG. 5 is a cross-section showing a dispersion process of glass beads in the sheet paper of the invention; and

FIG. 6 is a cross-section showing irregular reflection by the sheet paper of the invention.

### BEST MODE

The present invention relates to a sheet paper for irregular reflection (hereinafter, r eferred to as a ‘sheet paper’) and a method of fabricating the same. The sheet paper of the invention comprises: a coating layer on which a hemispherical embossing is repeatedly formed at the one side of the sheet paper, a colored transparent paint film layer formed at the bottom surface of the coating layer having the embossing formed thereon, a glass bead layer formed on the bottom surface of the colored transparent paint film and having glass beads dispersed therein, a colorless transparent paint film layer formed on the bottom surface of the glass bead layer, and a silver paint film layer formed on the bottom surface of the colorless transparent paint film layer, wherein the glass beads are uniformly distributed and fixed in the colored transparent paint film layer and the colorless transparent paint film layer in such a manner that the surface of each bead is embedded in both layers by a half of the bead diameter respectively.

In addition, the method of fabricating a sheet paper comprises steps of: forming an embossing having a shape of hemisphere in one side of a coating layer 50 by using a roller 60 with a projection 61 provided thereon (S1);

coating a colored transparent paint film on the bottom surface of the coating layer 50 having the embossing 51 formed thereon to form a colored transparent paint film layer 40 (S2);

dispersing a glass bead 20 on the bottom surface of the above-formed colored transparent paint film layer 40 through a screen 80 to form a glass bead layer (S3);

coating a colorless transparent paint on the bottom surface of the above-formed glass bead layer to form a colorless transparent paint film layer 30 (S4); and

forming a silver paint film layer 10 on the bottom surface the above-formed colorless transparent paint film layer 30 (S5).

### Mode for Invention

Hereafter, the preferred embodiments of the present invention will be described in detail, with reference to the accompanying drawings, such that a person having ordinary skills in the art can practice readily the technical spirit of the present invention.

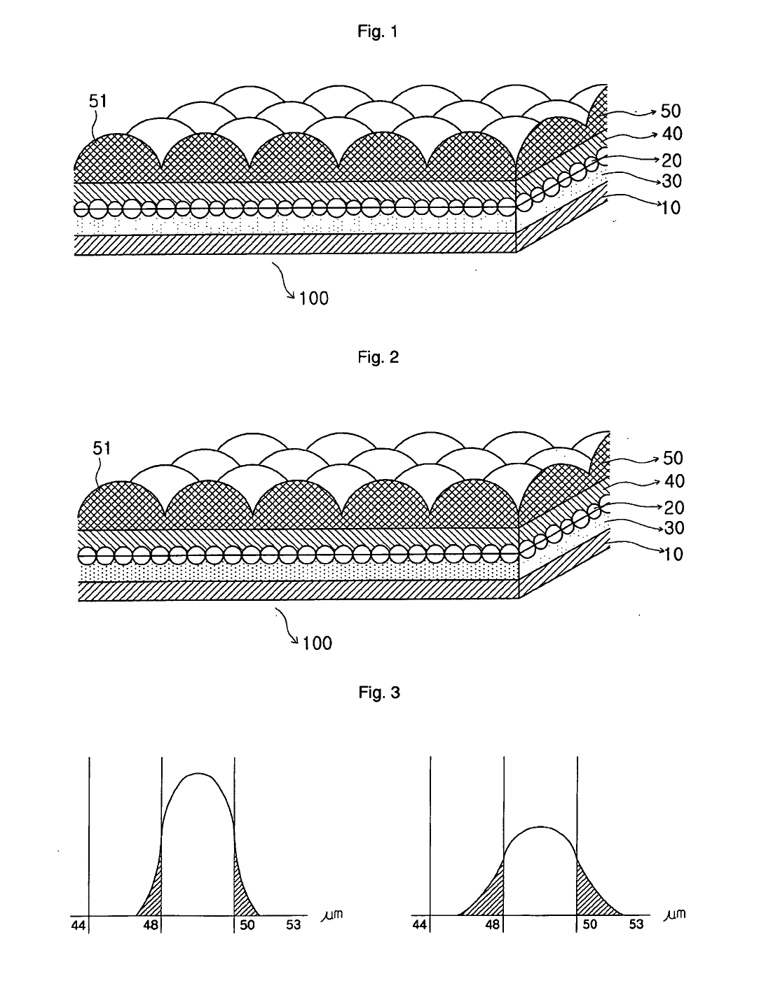

FIG. 1 shows a cross-section of a sheet paper having a glass bead particle layer, in which a shaft-type bead and a round-type bead are mixed at a ratio of 50:50 according to the invention. The sheet paper 100 of the invention is composed, from the top thereof, of a coating layer 50 on which a hemispherical embossing 51 is repeatedly formed at one side of the sheet paper, a colored transparent paint film layer 40 formed beneath the coating layer having the embossing 51, a glass bead layer formed beneath the colored transparent paint film layer 40 and having glass beads 20 dispersed therein, a colorless transparent paint film layer 30 formed beneath the glass bead layer, and a silver paint film layer 10 formed beneath the colorless transparent paint film layer 30.

The glass bead 20 dispersed in the glass bead layer is formed of a shaft-type bead and a round-type bead mixed at the ratio of 50:50. The glass beads are uniformly distributed and fixed in the colored transparent paint film layer 40 and the colorless transparent paint film layer 30 in such a manner that the surface of each bead is embedded in both layers 30, 40 by a half of the bead diameter respectively.

As described above, since the hemispherical embossing 51 is formed on the top of the coating layer 50, the light is secondarily refracted through the coating layer 50 formed of the embossing 51, as shown in FIG. 6, thereby maximizing the effect of irregular reflection. In addition, irregular reflection can occur on the embossing 51 of the coating layer 50 so that an excellent discrimination power can be achieved at the nighttime. After shaft-type beads and round-type beads are uniformly dispersed at the ratio of 50:50, if a colorless transparent paint is coated, the glass bead 20 and the colorless transparent paint are optimally distributed, thereby enabling maximization of the reflection efficiency.

The glass bead 20 used in the sheet paper is comprised of the shaft-type and the round-type mixed together at the ratio of 50:50, and is dispersed with excellent dispersion evenness.

FIG. 2 illustrates a cross-section of a sheet paper having a uniform glass bead layer according to the invention. This embodiment is composed of the same layers as in the sheet paper 100 in FIG. 1, except that a glass bead 20 of uniform particle size is densely dispersed, dissimilar to FIG. 1, thereby maximizing the reflection efficiency.

A material used as the coating layer 50 is exemplified by a thermoplastic urethane elastomer (TPU), which has a good durability, cold-resistance, and heat-resistance, and an environmental acceptability. In order to embed uniformly the glass bead 20 in the colored transparent paint film layer 40 and the colorless transparent paint film layer 30 respectively by the half of the bead diameter, a polyurethane resin-based material must be employed as the colored transparent paint, colorless transparent paint, and transparent resin materials.

The silver paint contains aluminum paste in a range of 15 to 20 wt % to thereby maximize the reflection effect. If the content of aluminum paste is less than 15 wt %, the reflection effect is degraded. Aluminum paste above 20 wt % results in an economical inefficiency.

Here, the glass bead 20 used for the recursive reflection or irregular reflection is explained. The glass bead 20, which is a glass ball such as a ceramic ball of high purity, has a shape of spherical ball, and thus exhibits an identical stress for any directional force and also geometrically a highest stress in all directions. The glass material provides a good chemical stability, including water resistance, alkali resistance, acid resistance, chemical resistance, soluble resistance, and heat resistance.

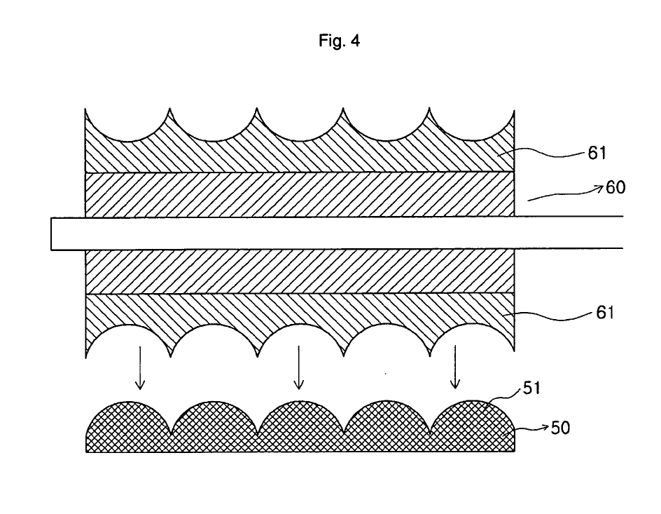

The dispersion mode of the glass bead 20 includes a shaft-type and a round-type. As shown in FIG. 3, the shaft-type contains mainly particles of 47˜50 mm and a very small amount of 44 to 47 mm and 50 to 53 mm. The round-type contains larger amount of 47 to 52 mm particles and the particles of 44 to 47 mm and 50 to 53 mm are contained in a smaller amount than that of 47 to 53 mm, but more or less uniformly distributed.

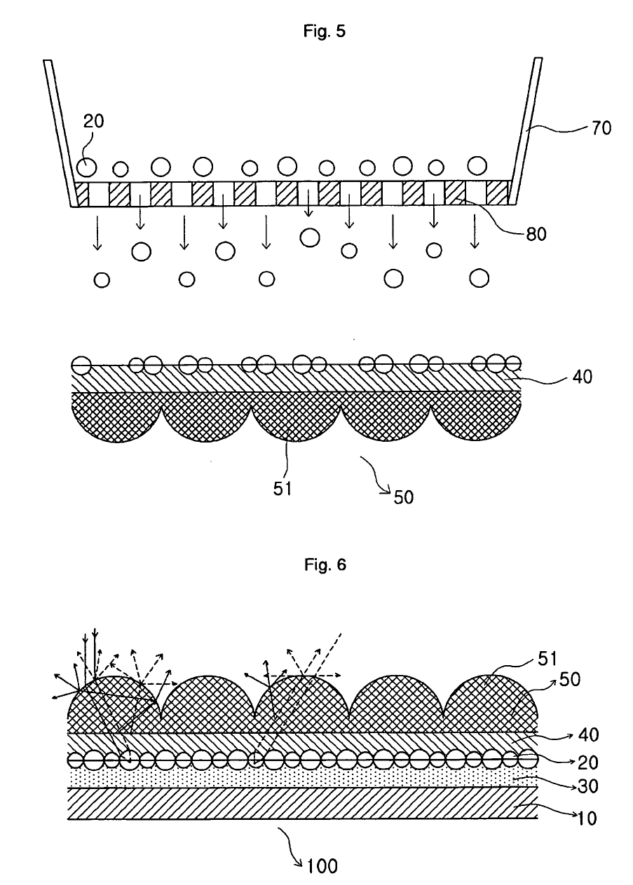

A method of fabricating the sheet paper 100 of the invention will be described in greater detail, in conjunction with FIGS. 4 and 5.

FIG. 4 is a cross-section showing a formation process of the embossing in the sheet paper of the invention, and FIG. 5 is a cross-section showing a dispersion process of glass beads in the sheet paper of the invention.

First, referring to FIG. 4, the process for forming the embossing on the coating layer will be explained. A roller having a plurality of projections 61 formed in the outer surface thereof is employed in order to form the embossing 51 in one side of the coating layer 50. When the roller 60 heated up to a certain temperature is rolled in the coating layer 50, the projections 61 presses the coating layer 50 in the direction marked by arrows to form the embossing 51. The formed embossing 51 has a shape of hemisphere, which is the same as that of the glass bead 20, and thus does not degrade the reflection efficiency of the glass bead 20. (Embossing forming step: S1)

Next, in order to readily understand the bead dispersion process as shown in FIG. 5, it should be noted that the sheet paper 100 shown in FIGS. 1 and 2 is manufactured in an up-side-down state in practice.

Referring to FIG. 5, the process for forming a colored transparent paint film layer 40 and a colorless transparent paint film layer 30 on the bottom surface of the coating layer 50 having the embossing 51 is will be described. First, the coating layer 50 is up-side-down in order for the embossing 51 to direct downwardly, and a colored transparent paint is applied to the bottom surface of the coating layer 50 having the embossing 51 formed thereon in order to form the colored transparent paint film layer 40. (Colored transparent paint film layer forming step: S2)

Afterwards, in order to form a glass bead layer on the top of the colored transparent paint film layer 40, glass beads 20 of about 44˜53 mm are dispersed on the above-formed colored transparent paint film layer 40 from a glass bead storage 70 via a screen 80 of above 325 mesh disposed therebelow. The glass bead storage 70 contains a shaft-type and round-type glass beads mixed at the ratio of 50:50. (Glass bead layer forming step: S3)

Similarly, in the sheet paper 100 shown in FIG. 2, which has a glass bead layer formed of glass beads 20 of uniform diameter, the glass bead layer can be formed by the same process as described above, i.e., by dispersing a uniform glass bead 20 on the top of the colored transparent paint film layer 40 through the screen 80.

A colorless transparent paint is applied to the top of the above-formed glass bead layer to form a colorless transparent paint film layer 30. (Colorless transparent paint film layer forming step: S4)

In the step S3 of forming the glass bead layer, when the glass bead 20 is dispersed, 12˜15 glass beads 20 are distributed in the rear surface of the embossing 51. One half of the glass bead 20 diameter is embedded and fixed in the colored transparent paint film layer 40, and the other half of the diameter thereof is embedded and fixed in the colorless transparent paint film layer 30, and then they are dried for 5 to 7 minutes at 120° C.

As described above, in order for the glass bead 20 to be embedded in the colored transparent paint film layer 40 and the colorless transparent paint film layer 30 equally by one half of its diameter, a polyurethane resin based material must be employed as the colored transparent paint and the colorless transparent paint in the invention. In addition, after the glass bead 20 is dispersed on the top of the colored transparent paint film layer 40 and the colorless transparent paint is applied thereto, some degree of natural curing is occurred and then the solvent contained in the colorless transparent paint is scattered to move the glass beads 20, when the glass bead 20 is embedded and fixed in the colored transparent paint and the colorless transparent paint film layer.

Since the glass bead 20 is dispersed through the screen 80, the arrangement of the glass beads 20 can be optimized. In addition, when the colorless transparent paint is applied such that it coats uniformly the glass bead 20 by one half of the surface thereof. If more than one half of the glass bead 20 diameter is coated, the escape or wear of the glass bead 20 can be prevented, but the reflection efficiency is degraded. When less than one half of the glass bead 20 diameter is coated, the reflection efficiency is enhanced, but the escape or wear of the glass bead 20 might occur. Typically, one half of the glass bead 20 surface is coated in a colorless transparent paint film layer 30, but the reflection efficiency becomes degraded due to inaccuracy of the coating.

Finally, although not shown in FIG. 5, a silver paint is applied to the top of the colorless transparent paint film layer 30 in the same way as in the colored transparent paint film layer forming step (S2), and thereafter dried completely for 1˜2 hours at 120° C. to obtain a silver paint film layer 10. (Silver paint film layer forming step: S5)

According to the contents of the steps S1 to S5, the method of fabricating a sheet paper of the invention will be summarized as follows.

The method of the invention includes the steps of:

forming an embossing having a shape of hemisphere in one side of a coating layer 50 by using a roller 60 with a projection 61 provided thereon (S1);

coating a colored transparent paint film on the bottom surface of the coating layer 50 having the embossing 51 formed thereon to form a colored transparent paint film layer 40 (S2);

dispersing a glass bead 20 on the bottom surface of the above-formed colored transparent paint film layer 40 through a screen 80 to form a glass bead layer (S3);

coating a colorless transparent paint on the bottom surface of the above-formed glass bead layer to form a colorless transparent paint film layer 30 (S4); and

forming a silver paint film layer 10 on the bottom surface the above-formed colorless transparent paint film layer 30 (S5).

In the above method, when the glass bead 20 is dispersed on the top of the colored transparent paint film layer 40, one half surface of the glass bead diameter is embedded and fixed in the colored transparent paint film layer 40, and the other half surface of the diameter thereof is embedded and fixed in the colorless transparent paint film layer 30 formed by the colorless transparent paint, and then they are dried for 5˜7 minutes at 120° C.

The sheet paper 100 manufactured above can be utilized in various industries, in particular, a safety product such as a nighttime distinguishing product, including a load sign or a safety vest for nighttime workers, as well as a decoration materials for shoes, bags, and clothes, or decoration accessories, or other products for decoration.

As described above, when the sheet paper 100 is used in various products, it produces a three-dimensional color reflection and scattering effect. That is, as shown in FIG. 6, the light reflected by the refraction of incident light is primarily refracted and reflected inside the embossing coating layer 50 and again secondarily refracted and reflected inside the glass bead 20. When reflected, a visual irregular reflection effect is generated in the embossing 51 of the coating layer 50 so that the shape and color of a product can be discernible where light is not illuminated.

In addition, the above steps may be, in reverse, carried out by using a common release agent, i.e., a silver paint film layer 10 is formed on the top of the release agent, a colorless transparent paint film layer 30 is formed on the top of the silver paint film layer 10, a glass bead is dispersed on the top of the colorless transparent paint film layer 30 to form a glass bead layer, a colored transparent paint film layer 40 is formed on the top of the glass bead layer, and a coating layer 50 is formed on the top of the colored transparent paint film layer 40.

### INDUSTRIAL APPLICABILITY

According to the sheet paper of the invention, an embossing is formed on the top of a coating layer, a paint film is formed with a transparent paint, and then a glass bead is uniformly dispersed in the paint film layer to thereby provide an optimum arrangement of glass beads, and the light primarily reflected on a silver paint layer through the glass bead is secondarily refracted through the coating layer formed of embossing to thereof maximize irregular reflection efficiency.

1. A sheet paper for irregular reflection, comprising: from the top thereof, a coating layer 50 on which a hemispherical embossing 51 is repeatedly formed at one side of the sheet paper, a colored transparent paint film layer 40 formed at the rear surface of the coating layer 50 having the embossing 51 formed thereon, a glass bead layer formed below the colored transparent paint film layer 40 and having glass beads 20 dispersed therein, a colorless transparent paint film layer 30 formed below the glass bead layer, and a silver paint film layer 10 formed below the colorless transparent paint film layer 30, wherein the glass beads 20 are uniformly embedded and fixed in the colored transparent paint film layer 40 and the colorless transparent paint film layer 30 in such a manner that the surface of each bead is embedded in both layers 30,40 by a half of the bead diameter respectively.

2. The sheet paper according to claim 1, wherein the glass bead 20 dispersed in the glass bead layer is formed of a shaft-type bead and a round-type bead mixed at the ratio of 50:50.

3. The sheet paper according to claim 1, wherein the glass bead layer is formed of densely dispersed glass beads 20 having a uniform size.

4. The sheet paper according to claim 1, wherein the coating layer 50 is formed of a polyurethane elastomer material, and a paint and transparent resin used for the colored transparent paint film layer 40, the colorless transparent paint film layer 30, and the silver paint film layer 10 is a polyurethane resin based material.

5. A method of fabricating a sheet paper for irregular reflection, the method comprising the steps of:
forming an embossing having a shape of hemisphere in one side of a coating layer 50 by using a roller 60 with a projection 61 provided thereon (S1);
coating a colored transparent paint film on the bottom surface of the coating layer 50 having the embossing 51 formed thereon to form a colored transparent paint film layer 40 (S2);
dispersing a glass bead 20 on the bottom surface of the above-formed colored transparent paint film layer 40 through a screen 80 to form a glass bead layer (S3);
coating a colorless transparent paint on the bottom surface of the above-formed glass bead layer to form a colorless transparent paint film layer 30 (S4); and
forming a silver paint film layer 10 on the bottom surface the above-formed colorless transparent paint film layer 30 (S5).

6. A method of fabricating a sheet paper for irregular reflection, in which the method according to claim 5 is in reverse carried out by using a common release agent, wherein a silver paint film layer 10 is formed on the top of the release agent, a colorless transparent paint film layer 30 is formed on the top of the silver paint film layer 10, a glass bead is dispersed on the top of the colorless transparent paint film layer 30 to form a glass bead layer, a colored transparent paint film layer 40 is formed on the top of the glass bead layer, and a coating layer 50 is formed on the top of the colored transparent paint film layer 40.

7. The method according to claim 5, wherein one half surface of the diameter of the glass bead 20 in the glass bead layer is embedded and fixed in the colored transparent paint film layer 40 and the other half thereof is embedded and fixed in the colorless transparent paint film layer 30 formed by a colorless transparent paint.

8. The method according to claim 5, wherein the coating layer 50 is formed of a polyurethane elastomer material, and a paint and transparent resin used for the colored transparent paint film layer 40, the colorless transparent paint film layer 30, and the silver paint film layer 10 is a polyurethane resin based material.
